(19) United States
(12) Patent Application Publication
(10) Pub. No.: US 2013/0151632 A1
(43) Pub. Date: Jun. 13, 2013

(54) METHOD AND SYSTEM FOR MANAGING SOCIAL RELATIONSHIPS

(71) Applicants: Prasad A. Chodavarapu, Bangalore (IN); Subramaniam Turuvekere, Bangalore (IN)

(72) Inventors: Prasad A. Chodavarapu, Bangalore (IN); Subramaniam Turuvekere, Bangalore (IN)

(73) Assignee: HCL AMERICA INC., SUNNYVALE, CA (US)

(21) Appl. No.: 13/324,086

(22) Filed: Dec. 13, 2011

(51) Int. Cl. G06F 15/16

(52) U.S. Cl. 709/206; 709/204

(57) ABSTRACT

A system and method to manage social relationships by gathering information about social relationships for a particular user from a variety of sources, and automatically to recommend or execute potential socially desirable actions by the particular user with respect to the relationship. The method includes automatically aggregating social relation data from a plurality of social media, maintaining social relationship information for a plurality of social relations based on aggregated social relation data, automatically identifying potentially socially desirable actions by the user, and alerting the user to the identified desirable actions, or automatically executing the desirable actions.

### TECHNICAL FIELD

This patent document pertains generally to the management of social relationship information, and more particularly, but not by way of limitation, to a method and system for managing social relationships.

### BACKGROUND

The social sphere of the individual has broadened in modern society due to technological advances. Social interactions may occur via a variety of social media, for example by e-mail, social websites, instant messaging (IM), and the like. Keeping track and record of a multitude of relationships and contact information that is dispersed through a variety of systems may be challenging.

Due to the large number of relationships that a modern person may have to maintain, it is easy to be unaware of or to forget taking those actions that may foster a particular relationship and/or that may be of service to friends or relations. Increasingly multicultural societies further place a high onus on users to act in a socially sensitive way with respect to individuals from a variety of demographic groups.

### BRIEF DESCRIPTION OF DRAWINGS

Some embodiments are illustrated by way of example and not limitation in the figures of the accompanying drawings in which:

FIG. 1 is a schematic diagram illustrating a system for managing social relationship, the system being implemented in a distributed network environment, according to an example embodiment.

FIG. 2 is a diagrammatic representation of a social relationship administration system, as may be used in an example embodiment.

FIG. 3 is a more detailed diagrammatic representation of the social relationship administration system of FIG. 2, in accordance with an example embodiment.

FIG. 4 is a diagrammatic representation of a client device that is configured to report social relation data to a social relationship administration system, in accordance with an example embodiment.

FIG. 5 is a flow chart illustrating a method to manage social relationships, according to an example embodiment.

FIG. 6 is a flowchart illustrating a method to manage social relationships, according to another example embodiment.

FIG. 7 is a block diagram of a machine in the example form of a computer system within which a set instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that embodiments of the present disclosure may be practiced without these specific details.

In one embodiment there may be provided a system and method to manage social relationships by gathering information about social relationships for a particular user from a variety of sources, and automatically to recommend or execute potential socially desirable actions by the particular user with respect to the relationship.

The system may include a social relation data aggregator to automatically aggregate social relation data from a plurality of social communication media, each social communication medium providing a chan for communication between a user and one or more of a plurality of social relations. The plurality of social communication media may comprise a plurality of types of social communication media, e.g., comprising two or more of a mobile telephone service, a social networking website, an e-mail service, and an instant messaging service, instead, or in addition, the plurality of social communication media may comprise a plurality of instances of at least one type of social communication media, for example comprising three different social websites, and/or two distinct e-mail accounts.

The social relation data aggregator may include a relationship aggregator to identify in a specific one of the plurality of social communication media anew social relation which is not included in the social relationship information; to retrieve social relation data with respect to the new social relation from the specific social communication medium; and to include a relationship with respect to the new social relation in the social relationship information, there to aggregate the plurality of relationships from the plurality of social communication media. The relationship aggregator may thus be configured automatically to create new social relationships responsive to identification of social interactions with a new social relation.

The social relation data aggregator may include an interaction aggregator to aggregate from the plurality of social communication media information regarding interactions between the user and respective social relations. Such interactions may comprise e-mails, IMs, telephone calls, posts on social websites, messages on social websites, and the like.

The social relation data aggregator may further include an event aggregator to aggregate from the plurality of social communication media events relevant to the user and/or to one or more of the plurality of social relations. Such events may be scheduled events and/or past events and may include, for example, scheduled meetings, hotel bookings, flight bookings, location data of the user, etc.

The social relation data aggregator may be configured to aggregate social relation data by interrogating various social communication media systems, and/or by receiving social relation data updates from programmatic components installed in the respective social communication media devices. The mobile telephones or personal computers of social relations may thus be configured automatically to report social relation data to the social relation data aggregator.

An example embodiment of the system further comprises a relationship manager to maintain social relationship information with respect to the plurality of social relations of the user based on aggregated social relationship data, the social relationship information defining a plurality of relationships between the user and respective social relations.

The relationship manager may include a template manager to associate a behavior template with the particular social relation, the behavior template comprising a set of rules and/or values for identifying potential needs and/or desires of the associated social relation, the recommendation engine being configured to identify the potential socially desirable action based at least in part on the behavior template. The nature of recommendations provided by the recommendation manager with respect to a particular social relation may thus automatically be tailored to take into account the identity or preferences of the social relation, or to satisfy a mode of behavior defined or selected by the user. The behavior template may thus be a demographic template that defines rules and/or values pertaining to individuals forming part of a particular demographic group, the template manager further being configured to maintain a plurality of predefined demographic templates regarding a plurality of respective demographic groups. Demographic groups for which respective templates may be maintained may include, for example, age, gender, cultural group, nationality, behavior patterns, interest groups, and the like.

The template manager may be configured automatically to identify a particular demographic group to which the particular social relation belongs, and automatically to associate a corresponding demographic template to the particular social relation. Instead, or in addition, the template manager may be configured to associate the demographic template with the particular social relation in response to receiving user input indicating the association of the demographic template with the particular social relation, the template manager being configured to perform the prior operation of presenting the plurality of predefined demographic templates to the user, the user input comprising selection of the demographic template. Instead or in addition, the behavior template may be a target behavior template that defines rules and/or values pertaining to a target behavior of the user with respect to the particular social relation. A user may thus, for example, wish to behave with respect to a particular social relation in a certain manner or to meet a certain goal, and may apply a corresponding target behavior template to that social relationship.

A recommendation engine may be provided to automatically identify a potential socially desirable action by the user with respect to a particular one of the plurality of social relations, the recommendation engine being configured to identify the potential socially desirable action based at least in part on the social relationship information. A socially desirable action may be identified responsive to identifying a potential want or need by the particular social relation for the performance of a future action by the user. The recommendation engine may be configured to identify the potential socially desirable action based at least in part on aggregated interactions and/or aggregated scheduled events pertaining to the user and/or one or more of the plurality of social relations.

The system may further include a prompt generator to generate an action prompt with respect to the identified potential socially desirable action. The prompt generator may be configured to generate an alert message to the user, to alert the user to the identified potential socially desirable action. Such an alert message may be sent to a client device associated with the user, and/or to a website or similar forum which is frequented by the user. Instead, or in addition, the prompt generator is configured to generate an action trigger to cause automatic performance of the future action associated with the identified want and/or need. In some instances, the prompt generator may thus, for example, automatically generate and send an e-mail message or Web post to execute the identified potential socially desirable action.

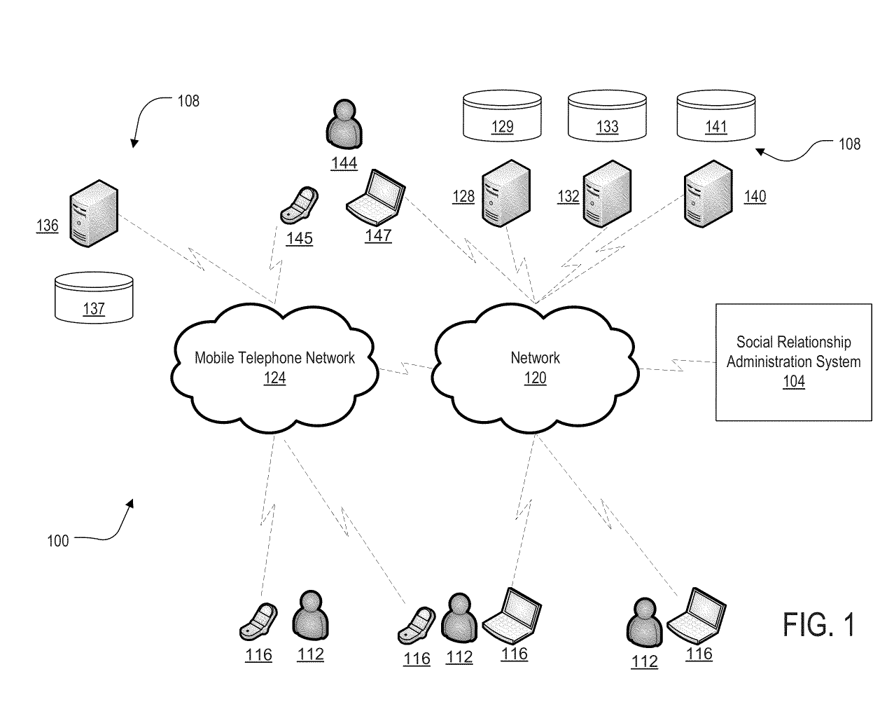

FIG. 1 is a schematic diagram of an example environment 100 within which a system 104 to manage social relationships may be implemented. The environment 100 may include a plurality of social communication media 108 that may allow a plurality of users 112 to communicate with each other on a plurality of social media platforms. The environment 100 may thus include a plurality of user devices 116 such as mobile telephones, personal computers, Web tablets, and the like. Social interactions between respective users 112 by means of the user devices 116 may be by way of one or more of a plurality of social communication media 108, and the present example including, for example, a mobile telephone service, a social networking website, an e-mail service, and an instant messaging service.

Configurations between the respective user devices 116 may be supported by a communication infrastructure that includes a distributed computer network 120, typically the Internet and mobile telephone networks 124. The social communication media 108 may be supported by respective support systems, each of which is diagrammatically indicated in FIG. 1 by a Web server and the associated memory in the form of a database. It should be appreciated, however, that each of the support systems may comprise a widely dispersed system of computers and/or processors, as well as a plurality of memories or databases that may be geographically dispersed. The social media support systems may include, for example, an e-mail system 128 to provide e-mail communication between respective user devices 116. The e-mail system 128 may additionally provide calendar and contact information for each of the users 112. A mail server database 129 forming part of the e-mail system 128 may store user/subscriber information, e-mail information, calendar information, contact information, event information, and the like. A social website support system 132 may provide and administer an online social network, for example by providing asocial networking website (e.g., Facebook, MySpace, Twitter, or the like). The social website support system 132 may include a social networking database 133 on which information indicative of user/subscriber details, social network details, communications via the social networking website (e.g., status updates, messages, posts, scheduled events, and the like).

Social interactions between user devices 116 may further be facilitated by a social communication medium provided by a mobile telephone service system 136 having a transaction database 137, and by an instant messaging service 140 having an instant message database 141. It will be appreciated that there may be significant interaction and cooperation between the respective support systems 128-141, and that two or more of the functions described with reference to respective systems may be performed by a single system. Thus, for example, social interactions via the social communication medium of instant messaging may be facilitated by the mobile telephone service system 136 or by the instant messaging service 140. It is to be appreciated that, for ease of description, only a single one of each type of communication system is illustrated in FIG. 1, but that there may be a plurality of different systems of the same type.

The system 104 provides a relationship administration system that is operable to manage or administer a plurality of relationships with each of a plurality of the users 112. For clarity of description, the management or administration of relationship information is further described with reference to the relationships of a particular user 144 with other users 112, who are referred to as the social relations 112 of the user 144. The user 144 is shown to have associated user devices 116 in the form of a mobile telephone 145 and a personal computer 147.

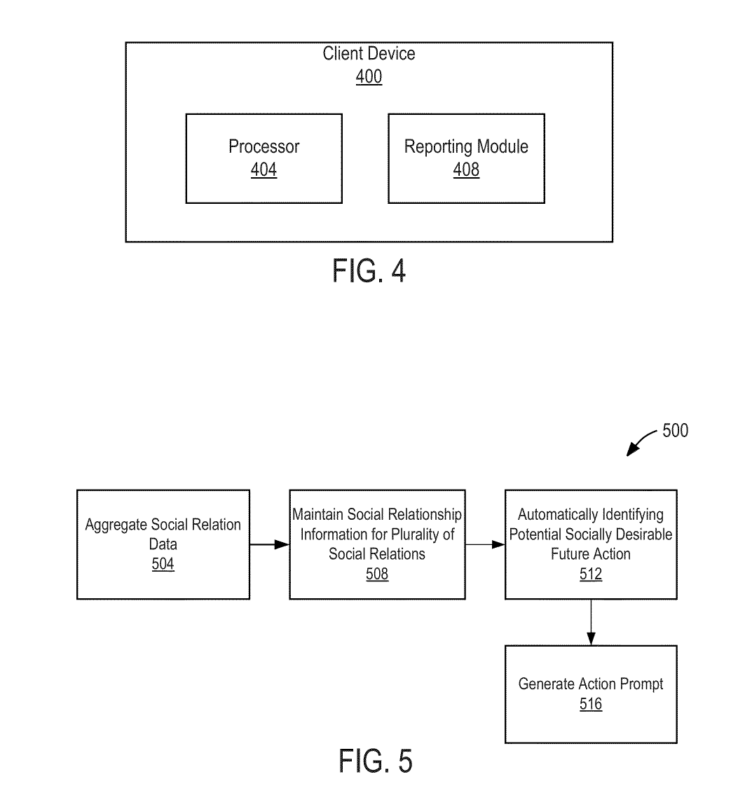

Although not illustrated in FIG. 1, at least some of the devices 116, 145, 147 may include a reporting module 408 (see FIG. 4) to report social interactions to the system 104. Thus, when, for example, the user 114 engages in instant messaging (IM) communications via an associated user device 116, the reporting module 408 may automatically generate an interaction report message providing an indication and/or details of the IM communication, and transmit the interaction report message to the system 104.

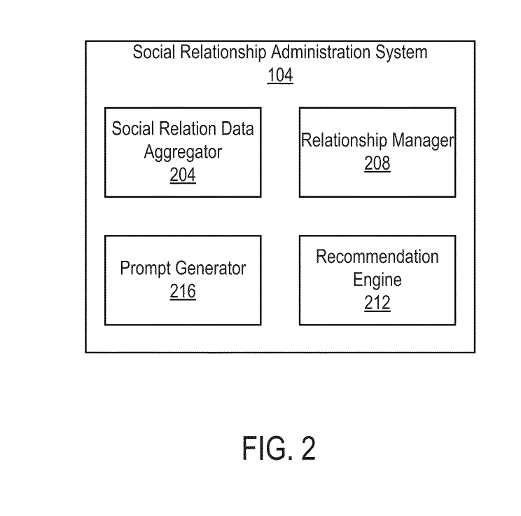

FIG. 2 schematically illustrates a high-level view of an example embodiment of the relationship administration system 104 that may be used in the environment 100 of FIG. 1. The system 104 may include a social relation data aggregator 204 to automatically aggregate social relation data from the respective systems providing the social communication media 108. The social relation data aggregator 204 may thus access at least some of the databases associated with the respective social communication media 108, to gather or aggregate information about social interactions, status updates, events, or the like associated with the user 144 and the social relations 112. The system 104 may further comprise a relationship manager 208 to maintain social relationship information with respect to a plurality of social relations of the user 144 based on social relationship data aggregated by the social relation data aggregator 204. The social relationship information may define plurality of relationships between the user 144 and users 112 who are respective social relations of the user 144.

A recommendation engine 212 is provided automatically to identify potential socially desirable actions that may be performed by the user 144 to satisfy potential social wants and/or needs of users 112 who are social relations of the user 144. The recommendation engine 212 may automatically monitor the social relationship information managed by the relationship manager 208, to identify potential socially desirable actions by the user 144. The system 104 may further include a prompt generator 216 to generate an action prompt with respect to the identified desirable action. The action prompt may be an alert message, for example a notice generated on a social networking website or an auto-generated e-mail message, to alert the user 144 of the desirable action, in another example, the action prompt may be an action trigger to cause automatic performance of the desirable action, e.g., by automatically generating an appropriate seasonal greeting message.

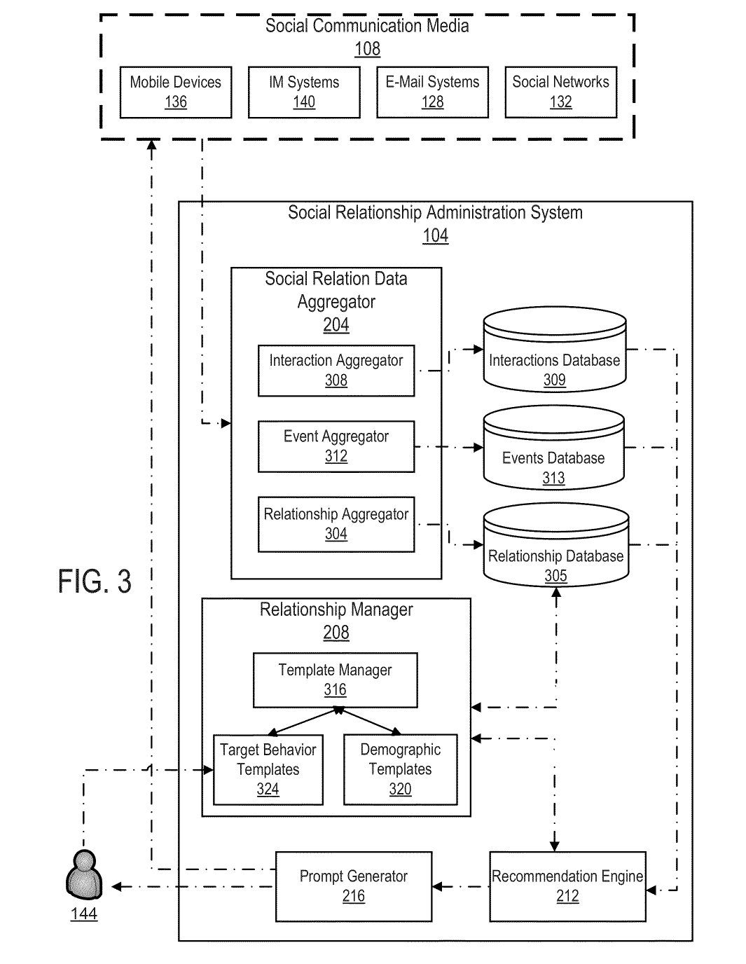

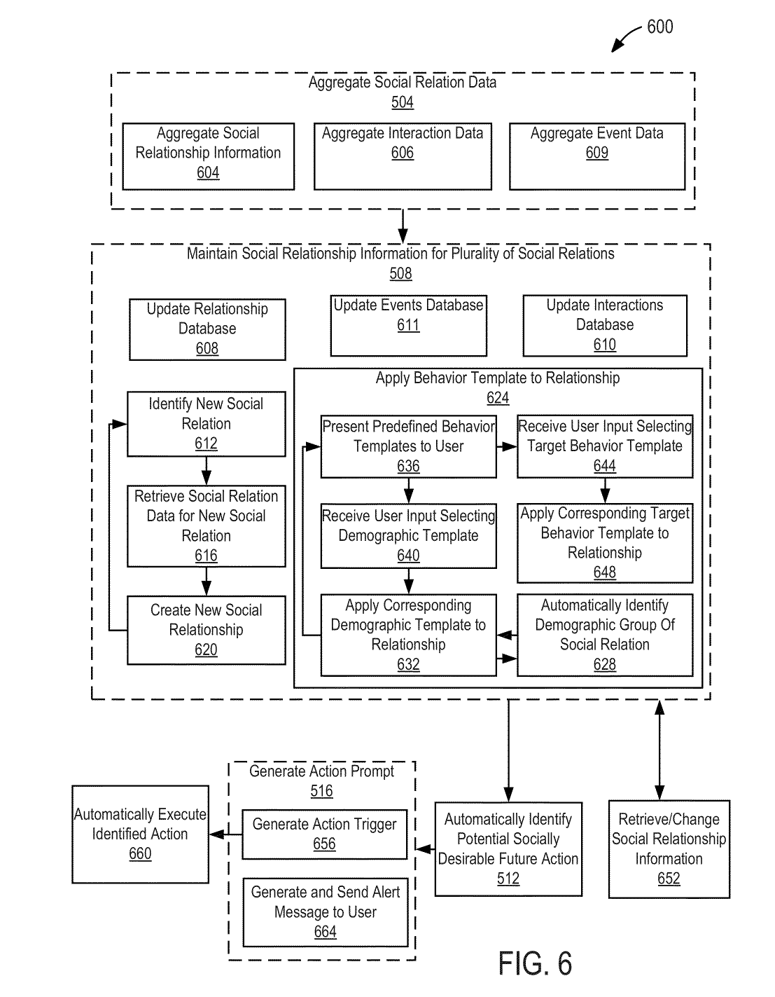

FIG. 3 is a more detailed view of a further example embodiment of the system 104 that may be used in the environment 100 of FIG. 1, Like reference numerals indicate like elements in FIGS. 1-2, and in FIG. 3. The social relation data aggregator 204 may include a relationship aggregator 304 to aggregate a plurality of relationships from the various social communication media 108, as described in greater detail below with reference to the method of FIG. 6. The relationship aggregator 304 is in communication with a relationship database 305 in which information or data regarding multiple aggregated relationships is stored. The social relation data aggregator 204 may further include an interaction aggregator 308 to aggregate social interactions from the various social communication media 108. The interaction aggregator 308 is in communication with an interactions database 309, in which information regarding the various aggregated social interactions is stored. The interaction aggregator 308 may thus, e.g., gather, collect, or aggregate social interactions from all of the social communication media 108 with which it is in communication, and may store information indicative of the respective indications (e.g., interaction identifiers and/or metadata with respect to the interactions) in an interactions database 309. Social interactions which are thus integrated may typically comprise communications between a social relation 112 and the user 144 via any one of the social communication media 108, and may include, for example: telephone calls to the user 144; messages or posts on a social website by, to, or about the user 144; e-mail messages by or to the user 144; and instant messages by or to the user 144.

An event aggregator 312 may further be provided as part of the social relation data aggregator 204, to aggregate or collect from the plurality of social communication media 108 scheduled events relevant to the user 144 and/or relevant to one or more of the user's 112. Data indicative of the aggregated events may be stored in an events database 313 that is in communication with the event aggregator 312. Events with respect to which information may be gathered by the event aggregator 312 may include, for example, calendar information from the e-mail system calendars, mobile device calendars, social webpage event information, and the like of the user 144 and/or the social relations 112. Example events may include scheduled meetings, flights, hotel bookings, location data (such as GPS information) indicative of movement of the user 144 and/or the social relations 112, and the like. The events database 313 may also be provided with event information which is not specific to a user, such as for example cultural holiday information, sports event information, entertainment event information, and the like.

The relationship manager 208 may comprise a template manager 316 to associate a behavior template with at least some of the social relations 112 for which information is stored in the relationship database 305. Each behavior template comprises a set of rules and/or values for identifying potentially socially desirable actions with respect to the associated social relations 112. The recommendation engine 212 is configured to cooperate with relationship manager 208 to identify potential socially desirable actions with respect to a particular social relation 112 based at least in part on an associated behavior template.

The system 104 may thus include demographic templates 320 that define rules and/or values pertaining to behavior towards individuals forming part of particular demographic groups, in this regard, the social needs and/or wants of individuals belonging to different demographic groups may be different, and the demographic templates 320 are configured to accommodate these different social mores, traditions, and/or uses. Application of a demographic template 320 to a particular relationship therefore causes the recommendation engine 212 to generate recommendations taking into consideration the preferences of the associated demographic group, as reflected in the demographic template 320. For example, congratulating a person on certain anniversaries is not appreciated in some social groups, while it is desirable in other social groups. If, therefore a particular social relation is a member of a group that prefers not to be congratulated on an anniversary, this fact may be reflected in the associated demographic template 320, Likewise, actions that may be appropriate towards a social relation 112 that is male may be inappropriate when performed with respect to a female social relation 112, Demographic templates 320 may be with respect to, for example: demographic community, age, data collation, gender, interests, phase of life, behavior patterns, and the like, and may also be with respect to a combination of such features. Aspects of social interactions and/or desirable future social actions that may be reflected in the demographic templates 320 may include, for example: form of address, action preferences, cultural calendar information, desired actions related to cultural calendar, desired actions with respect to life events/milestones, and the like.

The template manager 316 may be configured automatically to associate demographic templates 320 with respective relationships and/or to associate demographic templates 320 with relationships based on user input. In the former instance, the relationship manager 208 may cooperate with the social relation data aggregator 204 automatically to identify particular demographic group(s) to which specific social relations 112 belong, and automatically to associate appropriate demographic templates 320 with such social relations 112. In the latter instance, the relationship manager 208 may be configured to present a plurality of predefined demographic templates 320 to the user 144 on a graphical user interface, and to associate selected demographic template(s) 320 with a particular social relation responsive to user selection of the demographic template(s) 320.

The relationship manager 208 may also include target behavior templates 324 that define rules and/or values pertaining to a desired behavior mode or target behavior of the user 144 with respect to associated social relations 112. The user 144 may, for example, wish to improve frequency of communication with a particular social relation 112, and may select a corresponding target behavior template 324. Other examples of target behaviors may include fostering a business relationship, improving pro-active support for needs of a personal nature, and so forth. In addition to a plurality of predefined target behaviors, the relationship manager 208 may also facilitate customization of a target behavior template 324 by the user 144, so that selected variables or attributes of a target behavior template 324 may selectively be changed by the user 144.

FIG. 4 schematically shows an example embodiment client device 400, for example being a mobile telephone device, which has a processor 404 and a reporting module 408 that is configured automatically to report social relation data to the social relation data aggregator 204. In an instance where the client device 400 is a mobile telephone (such as user device 116 of FIG. 1, being associated with a social relation 112), the reporting module 408 may thus automatically report social interactions that involve the user 144, such as for example an instant message (IM) sent to or from the user 144, the addition of contact details of a new person or individual, and the like. In some embodiments, the recommendation engine 212 may use location data regarding the movement of particular individuals to generate recommendations with respect to socially desirable actions. In such instances, the reporting module 408 may intermittently transfer location data (e.g., GPS data) indicative of its location to the social relation data aggregator 204.

FIG. 5 is a flow chart illustrating, at a high level, a method 500, in accordance with an example embodiment, to manage social relationships. The method 500 may be performed by any of the modules, logic, or components described above with reference to FIGS. 1-4. The method 500 may comprise automatically aggregating, at operation 504, social relation data from the plurality of social communication media 108, each social communication medium providing a channel for communication between the user 144 and one or more of the plurality of social relations 112. The method 500 further comprises maintaining social relationship information, at operation 508, with respect to the plurality of social relations based upon the aggregated social relationship data, the social relationship information defining a plurality of relationships between the user 144 and respective social relations 112. A potential socially desirable future action may automatically be identified, at operation 512, based on the social relationship information. The potential socially desirable future action may comprise identifying a potential want and/or need by one of the social relations 112 for the performance of a future action by the user 144. An action prompt may thereafter automatically be generated, at operation 516, with respect to the identified socially desirable action.

FIG. 6 is a flowchart illustrating in greater detail the example method 600 to manage social relationships in accordance with the example embodiment. Like reference numerals indicate like operations in FIG. 5 and in FIG. 6. Aggregating social relation data, at operation 504, may compromise aggregating social relationship information, at operation 604, from the plurality of social communication media 108. Such aggregation may comprise identifying individuals or persons who are social relations 112 of the user 144, and collecting or gathering, on a continual basis, information relevant to the social relations 112. Such information may include the identity, contact details, personal attributes, personal preference information, social network information, and the like. The social relationship information may be gathered by the relationship aggregator 304 by intermittently interrogating the respective social relationship media systems 132-141, by receiving updates or reports from the respective social relationship media systems 132-141, and/or by receiving social data reports from reporting modules 408 forming part of client devices 116. As mentioned above, social relation data may be gathered from, for example, a plurality of sources that may include both different types of social communication media (e.g., e-mail, social websites, IM, etc.), as well as from different instances of particular types of social communication media (e.g., both from Facebook and MySpace, and/or both from a work e-mail server and a Gmail account). Aggregation of social relationship information may be performed on a continuous, a continual, or an intermittent basis.

Social relationship information in the relationship database 305 may automatically be updated, at operation 608, based on newly aggregated social relationship information or data. Such updating promotes currency and relevancy of social relationship information, to facilitate the continuation of a relationship. For example, if a social relation 112 changes its address, changes its e-mail address, changes its telephone number, changes occupation or place of work, the relationship database 305 may automatically be updated to reflect the latest contact details, personal information, personal preferences, and the like, on the totality of the user's 144 social relations 112.

A relationship aggregator 304 may further automatically identify, at operation 612, new social relations 112 (e.g., a social relation 112 for whom there are no relationship records in the relationship database 305), upon which social relation data with respect to the newly identified social relation 112 is retrieved, at operation 616, and a new relationship record for the relevant relationship is included in social relationship information in the relationship database 305, at operation 620. The relationship aggregator 304 and/or the relationship manager 208 may thus automatically create a separate relationship record for each social relation 112 identified in any one of the multiple social communication media 108. The relationship aggregator 304 may, for example, create a separate relationship record in the relationship database 305 for each individual or social relation 112 identified in any one of a number of online social networks of the user 144 (e.g., Facebook, MySpace, multiplayer online games such Farmville, Cityville, or the like); contact information on mobile devices 116, e-mail contacts, etc. The effect is that expansion of the user's 144 social network in any one of the social communication media 108 automatically results in inclusion of the relevant new social relation in a centralized relationship database 305 or database system managed by the social relationship administration system 104.

Aggregation of social relation data, at operation 504, may further include aggregating interaction data, at operation 606. Similar to the aggregation of social relationship information, the aggregation of interaction data, at operation 606, may include receiving updates or communications from respective social communication media systems 132-141, gathering information from the respective social communication media 108 by interrogating or retrieving information therefrom, and/or receiving reports or communications from reporting modules 408 in client devices 116. In some instance, programmatic crawling agents may be employed to gather or collect the relevant data. Social interactions with respect to which interaction data is gathered may include, for example: e-mails, IMs, social website postings or listings, electronic invitations, meeting invitations, data from mobile device applications pertaining to social actions, and the like. The interaction aggregator 308 may automatically update the interactions database 309, at operation 610, responsive to receiving new interaction data.

The aggregation of social relation data, at operation 504, may yet further include aggregating event data, at operation 609, which may be performed similarly to the gathering of social relationship information and interaction data as described above. The event data may comprise indicators of scheduled events that involve the user 144 and/or at least some social relations 112 of the user 144. Events for which the event data is gathered may include, for example, scheduled meetings, social events, calendar events, sports/entertainment events, cultural events, hotel bookings, flight bookings, and the like. The event aggregator 312 may automatically update the events database 313, at operation 611, with newly received event data.

The maintaining of the social relationship information for the plurality of social relations, at operation 508, may include applying behavior templates to at least some of the relationships, at operation 624. The application of behavior templates to at least some relationships may be performed automatically, or may be in response to user direction. The relationship manager 208 may, for example, be configured to identify, at operation 628, at least one demographic group to which a particular social relation 112 belongs, and may thereafter automatically apply a corresponding demographic template to the particular relationship, at operation 632. The relationship manager 208 may, for example, determine from information stored in the relationship database 305 that a particular social relation 112 belongs to a Hindu cultural group, and may apply to the relationship a demographic template 320 that is designed and configured specifically to suggest/cause social behavior by the user 144 that is sensitive to and takes into account traditions, uses, and sensitivities of the corresponding Hindu community. More than one demographic template 320 may be applied to a particular relationship. If the relationship manager 208, for example, determines that a particular person is a Muslim male of advanced age, a demographic template 320 configured for males of the Muslim community, as well as a demographic template 320 configured for older people may be applied to the relationship. The predefined demographic templates 320 may in some instances be organized such that there are different templates for different subgroups within particular demographic groups. For example, there may be distinct demographic templates 320 for Muslim males and for Muslim females, distinct demographic templates for Shia Muslims and Sunni Muslims, and so forth. The demographic groups for which demographic templates 320 are predefined may thus be arranged at any desired granularity. The identification of demographic groups of social relations 112 may happen on an ongoing basis, so that if information is gathered and added to the relationship database 305 with respect to demographic affiliation of an existing relationship, an appropriate demographic template 320 may automatically be applied to that relationship.

Relationship manager 208 may further be configured to present a list of predefined behavior templates, at operation 636, to the user 144 on a graphic user interface, to allow the user 144 to select one or more behavior templates to apply to particular relationships. The 144 user may for example select, at operation 640, to apply a particular demographic template 320 to a particular relationship, upon which the selected demographic template 320 is associated with the relevant relationship, at operation 632. Instead, or in addition, the user 144 may select, at operation 644, a target behavior template 324 for a particular relationship. Relationship manager 208 may thereafter apply the selected target behavior template 324 to the relationship, at operation 648. Each target behavior template 324 or profile is configured to promote an associated target behavior with respect to the relevant social relation 112. Appropriate e-mail behavior or etiquette is, for example, different with respect to, on the one hand, a business relationship in which the target behavior is aimed at maintaining contact with the social relation 112 without being inappropriately familiar, and, on the other hand, a friendship in which the target behavior is to strengthen friendship bonds by being proactively available to meet the friends' personal needs. In some instances, a target behavior template 324 as well as one or more demographic templates 320 may be associated with a single relationship.

The user 144 may retrieve, change, or update the social relationship information, at operation 652. If the user 144, for example, wishes to obtain the telephone number for a particular social relation 112, the social relationship administration system 104 may be queried by the user 144 via a graphical user interface, the relevant information may be obtained from the relationship database 305, and may be presented to the user 144. The user 144 may also selectively or manually change relationship information by updating information not yet included by the social relationship administration system 104, by deleting undesired social relations 112 stored in the relationship database 305, and so forth.

The recommendation engine 212 may thereafter automatically identify potential socially desirable actions, at operation 512, based on the applied behavior templates and the aggregated social relationship information. The recommendation engine 212 may thus generate a recommendation based on information about social interactions stored in the interactions database 309, information about events stored in the events database 313, and/or information stored in the relationship database 305, together with any applied behavior templates. Upon identification of such a potential socially desirable action, the prompt generated 216 may generate an action prompt, at operation 516, with respect to the desirable action.

Generation of the action prompt may, for example, comprise generating an action trigger, at operation 656, that causes automatic execution of the identified desirable action, at operation 660. Such automatically executed desirable actions may include, for example, sending an online anniversary message, sending an online message congratulating a person with a life event, such as marriage, engagement, birth of a child, or the like. Such automatically generated messages or communications may be configured based on one or more applicable demographic templates 320 and/or target behavior templates 324. For example, forms of address may differ from culture to culture, and the alert message may thus automatically be formatted to conform to the cultural norms of the particular demographic group, Likewise, the tone of a message may be determined based an applicable target behavior template 324. For example, the tone of a birthday congratulation may be different for a close friend than it would be for a business relation.

Instead, or in addition, generation of the action prompt may comprise generating and sending an alert message, at operation 664, to the user 144. The alert message may be sent to a client device (such as mobile telephone 145 or personal computer 147) associated with the user 144 and may inform the user 144 of the type and date of identified desirable action with respect to the relevant social relation 112. Instead, the alert message may be posted to a social website or the like which is frequented by the user 144.

The recommendation engine 212 may, for example, determine that a friend of the user 144 is planning to relocate to the same city where the user 144 is resident, and may automatically identify that a potential socially desirable future action by the user 144 may be to offer to assist in the relocation, to offer to babysit the friend's young children (if the relationship database 305 indicates that the friend does have young children), to surprise the friend with a meal a day after relocation, to offer to take the friend on a tour of the new city, etc.

In another example, the recommendation engine 212 may determine, based on event data indicative of the location of a personal friend who is one of the social relations 112 (e.g., mobile phone GPS data), that the friend 112 is currently in the vicinity of the user 144, and may send an alert message to the user 144 suggesting the arrangement of a meeting with the visiting friend 112. Recommendations or action prompts may be generated not only based on future events, but also based on past events. For example, if a social relation 112 gave birth in the recent past, the social relationship administration system 104 may identify that the social relation 112 is a working woman who lives alone, and may at appropriate times generate and send an alert message to the user 144 suggesting that the user 144 offers to babysit the newborn.

Upon scheduling a trip to a particular destination (e.g., by booking a flight to or a hotel in the destination), the recommendation engine 212 may automatically identify all of the social relations 112 in the user's 144 relationship hierarchy, optionally identifying those social relations 112 who do not have prior appointments, and may send an alert message to the user 144 providing him with information on the possible social relations 112 to visit upon arrival at the destination. In another example, the recommendation engine 212 may identify that a social relation 112 of the user 144 wishes to send a parcel or package to someone in a destination to which the user 144 is traveling, in which case the recommendation engine 212 may generate and send an alert message to the user 144 to suggest that the user 144 offers to take the parcel to its intended recipient. The recommendation engine 212 may likewise identify, for example, based on mobile telephone GPS data, that one or more of the users social relations 112 have a similar daily commute, and may generate an alert message to the user 144 to suggest organizing a carpool with the identified social relations 112.

Yet a further embodiment, the recommendation engine 212 may identify based on interaction data in the interactions database 309 and/or based on event data in the events database 313 that a social relation 112 of the user 144 has a medical emergency in the vicinity of the user 144 and is in need of a blood transfer, and that the user 144 and the social relation 112 has the same blood group. The recommendation engine 212 may in such case automatically generate and send an alert message to alert the user 144 to the opportunity to be of assistance to the social relation 112.

The aggregation of multiple social relations 112 may also be employed advantageously by the user 144 to maximize the effectiveness of social actions. If, for example, the user 144 is exploring anew job opportunity and wants to find out more about the potential opportunity, the administration system 104 may be interrogated to provide an exhaustive list or a tailored list of potential social relations 112 to contact. Similarly, potential recipients of a group e-mail to elicit assistance for a social cause may easily and effectively be obtained from the relationship administration system 104.

It is an advantage of the method and system as described above that it manages multiple relationships of an individual. Such management by a centralized system reduces the likelihood of conflicting contact information for social relations 112. The system 104 also keeps track of all interactions with social relations 112 across various channels. A further advantage is that desirable social action by the user 144 is promoted by allowing the user 144 to define target profiles for each relationship.

The association of demographic templates 320 with respective relationships further provides culturally sensitive interactions by the user 144, and reduces the likelihood of a cultural faux pas such as, for example giving Christmas wishes to a non-Christian friend, or sending an inappropriate Diwali greeting.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

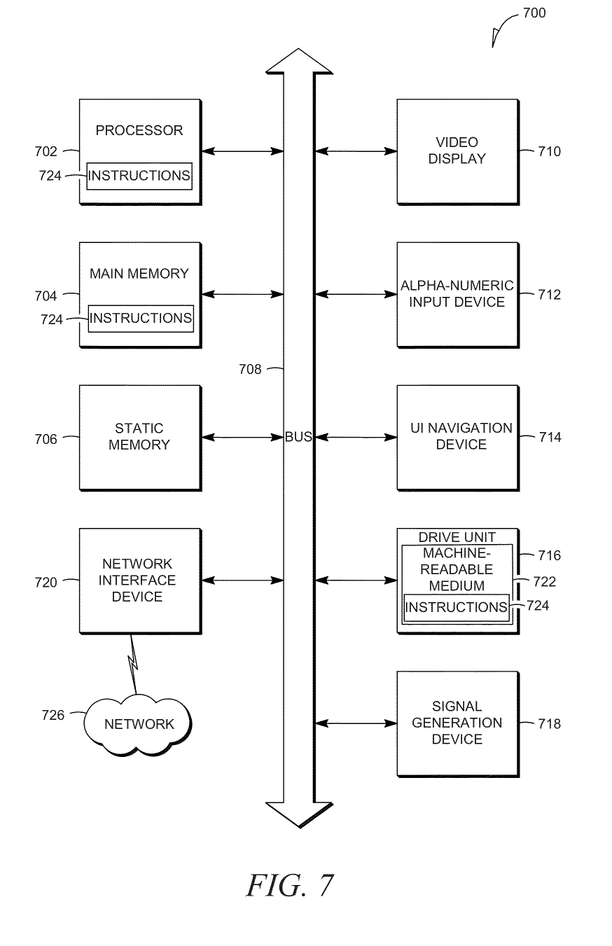

FIG. 7 is a block diagram of machine in the example form of a computer system 700 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by one or more processors, the method comprising:
automatically aggregating social relation data from a plurality of social communication media by use of the one or more processors, each social communication medium providing a channel for communication between devices respectively associated with a user and one or more of a plurality of social relations;
maintaining social relationship information with respect to the plurality of social relations of the user based on aggregated social relationship data, the social relationship information defining a plurality of relationships between the user and respective social relations;
automatically identifying, by use of the one or more processors and based on the social relationship information, a potential socially desirable action by the user with respect to a particular one of the plurality of social relations; and
generating an action prompt for the potential socially desirable action.

2. The method of claim 1, wherein the plurality of social communication media comprises two or more of a mobile telephone service, a social networking website, an e-mail service, and an instant messaging service.

3. The method of claim 1, further comprising associating a behavior template with the particular social relation, the behavior template comprising a set of rules and/or values for identifying potential needs and/or desires of the associated social relation, the operation of automatically identifying the potential socially desirable action being based at least in part on the behavior template.

4. The method of claim 3, wherein the behavior template is a demographic template that defines rules and/or values pertaining to individuals forming part of a particular demographic group, the method further comprising maintaining a plurality of predefined demographic templates regarding a plurality of respective demographic groups.

5. The method of claim 4, further comprising automatically identifying a particular demographic group to which the particular social relation belongs, and automatically associating a corresponding demographic template to the particular social relation.

6. The method of claim 5, wherein the associating of the demographic template with the particular social relation is in response to receiving user input indicating the association of the demographic template with the particular social relation, the method comprising a prior operation of presenting the plurality of predefined demographic templates to the user, the user input comprising selection of the demographic template.

7. The method of claim 3, wherein the behavior template is a target behavior template that defines rules and/or values pertaining to a target behavior of the user with respect to the particular social relation.

8. The method of claim 1, wherein the aggregating of social relation data includes aggregating the plurality of relationships from the plurality of social communication media, the aggregating of the plurality of relationships comprising:
identifying in a specific one of the plurality of social communication media a new social relation which is not included in the social relationship information;
retrieving social relation data with respect to the new social relation from the specific social communication medium; and
including a relationship with respect to the new social relation in the social relationship information.

9. The method of claim 1, wherein the aggregating of social relation data includes aggregating from the plurality of social communication media information regarding interactions between the user and respective social relations.

10. The method of claim 1, wherein the aggregating of social relation data includes aggregating from the plurality of social communication media events relevant to the user and/or to one or more of the plurality of social relations.

11. The method of claim 9, wherein the identifying of the potential socially desirable action is based at least in part on aggregated interactions and/or aggregated events pertaining to the user and/or one or more of the plurality of social relations.

12. The method of claim 1, wherein the aggregating of the social relation data comprises receiving, at a central aggregator, social relation data updates from programmatic components installed in respective social communication media devices to automatically transmit the social relation data updates to the central aggregator.

13. The method of claim 1, wherein the action prompt comprises an alert message to the user, to alert the user to the identified potential socially desirable action.

14. The method of claim 1, wherein the action prompt comprises an action trigger to cause automatic performance of identified.

15. A system comprising:
a social relation data aggregator to automatically aggregate social relation data from a plurality of social communication media, each social communication medium providing a channel for communication between a user and one or more of a plurality of social relations;
a relationship manager to, using one or more processors, maintain social relationship information with respect to the plurality of social relations of the user based on aggregated social relationship data, the social relationship information defining a plurality of relationships between the user and respective social relations;
a recommendation engine to automatically identify, using the one or more processors, a potential socially desirable action by the user with respect to a particular one of the plurality of social relations, the recommendation engine being configured to identify the potential socially desirable action based at least in part on the social relationship information; and
a prompt generator to generate an action prompt with respect to the identified potential socially desirable action.

16. The system of claim 15, wherein the plurality of social communication media comprises two or more of a mobile telephone service, a social networking website, an e-mail service, and an instant messaging service.

17. The system of claim 15, further comprising a template manager to associate a behavior template with the particular social relation, the behavior template comprising a set of rules and/or values for identifying potential needs and/or desires of the associated social relation, the recommendation engine being configured to identify the potential socially desirable action based at least in part on the behavior template.

18. The system of claim 17, wherein the behavior template is a demographic template that defines rules and/or values pertaining to individuals forming part of a particular demographic group, the template manager further being configured to maintain a plurality of predefined demographic templates regarding a plurality of respective demographic groups.

19. The system of claim 18, wherein the template manager is configured automatically to identify a particular demographic group to which the particular social relation belongs, and automatically to associate a corresponding demographic template to the particular social relation.

20. The system of claim 17, wherein the template manager is configured to associate the demographic template with the particular social relation in response to receiving user input indicating the association of the demographic template with the particular social relation, the template manager being configured to perform a prior operation of presenting the plurality of predefined demographic templates to the user, the user input comprising selection of the demographic template.

21. The system of claim 17, wherein the behavior template is a target behavior template that defines rules and/or values pertaining to a target behavior of the user with respect to the particular social relation.

22. The system of claim 15, wherein the social relation data aggregator includes a relationship aggregator to:
identify in a specific one of the plurality of social communication media anew social relation which is not included, in the social relationship information;
retrieve social relation data with respect to the new social relation from a specific social communication medium; and
include a relationship with respect to the new social relation in the social relationship information,
thereby to aggregate the plurality of relationships from the plurality of social communication media.

23. The system of claim 15, wherein the social relation data aggregator includes an interaction aggregator to aggregate from the plurality of social communication media information regarding interactions between the user and respective social relations.

24. The system of claim 15, wherein the social relation data aggregator includes an event aggregator to aggregate from the plurality of social communication media scheduled events relevant to the user and/or to one or more of the plurality of social relations.

25. The system of claim 23, wherein the recommendation engine is configured to identify the potential socially desirable action based at least in part on aggregated interactions and/or aggregated scheduled events pertaining to the user and/or one or more of the plurality of social relations.

26. The system of claim 15, wherein the social relation data aggregator is configured to receive social relation data updates from programmatic components installed in respective social communication media devices.

27. The system of claim 15, wherein the prompt generator is configured to generate an alert message to the user, to alert the user to the identified potential socially desirable action.

28. The system of claim 15, wherein the prompt generator is configured to generate an action trigger to cause automatic performance the identified action.
